(19) United States
(12) Patent Application Publication
(10) Pub. No.: US 2004/0152862 A1
(43) Pub. Date: Aug. 5, 2004

(54) Optical resins and applications thereof

(75) Inventors: Toshihiko Takasaki, Tsukuba-Shi (JP); Hikaru Urano, Tsukuba-Shi (JP); Hiromasa Kawai, Tsukuba-Shi (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: Hitachi Chemical Co., Ltd., Tokyo (JP)

(21) Appl. No.: 10/763,348

(22) Filed: Jan. 26, 2004

Related U.S. Application Data
(63) Continuation of application No. PCT/JP02/07545, filed on Jul. 25, 2002.

(30) Foreign Application Priority Data
Jul. 27, 2001 (JP) 2001-227927

(51) Int. Cl. C08G 73/06

(52) U.S. Cl. 528/176

(57) ABSTRACT

The present invention relates to an optical resin comprising a poly(benzoazole) having repeating units represented by the following general formula (1) as a constituent; and an optical waveguide, an optical filter and an optical lens prepared using the optical resin:

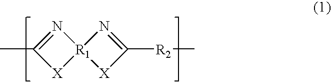

wherein R₁ represents a tetravalent organic group having an aromatic ring, N and X in each of the two sets thereof are linked to two atoms at the ortho-position on the aromatic ring of R₁ to form a 5-membered ring, R₂ represents a divalent organic group and X represents an oxygen atom or a sulfur atom.

The optical resin of the present invention has high transparency to light rays falling within the near infrared region, shows only small changes in the refractive index and the rate of birefringence as a function of wavelengths of light rays used for the measurement and falling within the near infrared region, has a low rate of birefringence and has high heat-resistance. Therefore, the optical resin of the present invention is suitably used as a resin for preparing optical parts, which are employed for the light rays falling within the wavelength range used in the optical communication.

### TECHNICAL FIELD thereof, in particular, the applications thereof as an optical waveguide, an optical filter and an optical lens.

### BACKGROUND ART

As a highly heat-resistant polymeric optical material used in the field of optical communication, there has been known a fluorine-containing polyimide. The structure and method for the preparation thereof are detailed in, for instance, Japanese Patent Nos. 2,657,700 and 2,813,713 and these patents disclose fluorine-containing polyimides each having a low refractive index and excellent transparency to the light rays used in the field of optical communication and falling within the near infrared range, while maintaining its high heat resistance.

On the other hand, poly(benzoazoles) such as poly(benzoxazole) and poly-(benzothiazole) have been investigated, for a long time, as materials each having a high heat resistance, a high strength and a high elastic modulus. The basic skeletons and methods for the preparation thereof are described in, for instance, Japanese Examined Patent Publication Sho 42-19721. Among them, there have been known several examples in which fluorine atoms are incorporated into poly(benzoxazoles) to thus reduce the dielectric constants and heat resistance of the polymers. Japanese Un-Examined Patent Publication Hei 11-181094 discloses a method for the preparation of a high molecular weight fluorine-containing poly(benzoxazole) and the use thereof as an interlayer insulating film for multi-layer wiring distributions of semiconductor devices. In addition, Japanese Un-Examined Patent Publication 2000-290374 discloses a fluorine-containing poly(benzoxazole) having a specific molecular structure and Japanese Un-Examined Patent Publication Hei 11-322929 discloses a poly(benzoazole) whose transparency to the light rays falling within the visible region is improved by the introduction of a highly bulky structure into the molecule, as an example of poly(benzoazoles) having improved optical characteristic properties.

The foregoing fluorine-containing polyimides are limited in the kinds of monomers used for constituting the polyimides and therefore, the preparation of resins excellent in the transparency and the birefringence starting from such polyimides is likewise limited. On the other hand, poly(benzoazoles) such as poly(benzoxazoles) and poly(benzothiazoles) have never been used as optical materials for optical communication and the poly(benzoazoles) having bulky structures incorporated therein and disclosed in Japanese Un-Examined Patent Publication 11-322929 have excellent transparency to the visible light rays, but they are inferior in the transparency to the light rays falling within the near infrared region used in the field of optical communication.

### DISCLOSURE OF THE INVENTION

Accordingly, it is an object of the present invention to provide an optical resin, which has excellent transparency to the light rays falling within the near infrared region, which shows only a slight change in the refractive index and the rate of birefringence depending on the wavelength used for the measurement thereof falling within the near infrared region, which has a low rate of birefringence as one of important optical characteristics and high heat resistance and which is thus suitably used as a resin for preparing optical parts used in the wavelength region for optical communication.

It is another object of the present invention to provide an optical part produced using the foregoing optical resin, in particular, an optical waveguide, an optical filter and an optical lens.

According to the present invention, there are provided an optical resin specified below and an optical waveguide, an optical filter and an optical lens produced using the optical resin.

(1) An optical resin comprising a poly(benzoazole) having repeating units represented by the following general formula (1) as a constituent:

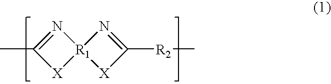

wherein R₁ represents a tetravalent organic group having an aromatic ring, N and X in each of the two sets thereof are linked to two atoms at the ortho-position on the aromatic ring of R₁ to form a 5-membered ring, R₂ represents a divalent organic group and X represents an oxygen atom or a sulfur atom.

(2) The optical resin as set forth in the foregoing item 1, wherein it comprises, as a constituent, a poly(benzoxazole) having repeating units represented by the general formula (1) in which X represents an oxygen atom.

(3) The optical resin as set forth in the foregoing item 2, wherein the poly(benzoxazole) is a fluorine-containing poly(benzoxazole).

(4) The optical resin as set forth in the foregoing item 3, wherein the fluorine-containing poly(benzoxazole) is a product obtained by a reaction of at least one bis(aminophenol) derivative with at least one dicarboxylic acid derivative; at least one member selected from the group consisting of the foregoing at least one bis(aminophenol) derivative and the foregoing at least one dicarboxylic acid derivative is a fluorine-containing derivative; and at least one member selected from the foregoing group is a fluorine-free derivative.

(5) The optical resin as set forth in the foregoing item 4, wherein the fluorine-containing bis(aminophenol) derivative is a trifluoromethyl group-containing bis(aminophenol) derivative and the fluorine-containing dicarboxylic acid derivative is a trifluoromethyl group-containing dicarboxylic acid derivative.

(6) The optical resin as set forth in the foregoing item 1, wherein it comprises, as a constituent, a poly(benzothiazole) having repeating units represented by the general formula (1) in which X represents a sulfur atom.

(7) The optical resin as set forth in any one of the foregoing items 1 to 6, wherein the number of the repeating units represented by the general formula (1) ranges from 1 to 500.

(8) The optical resin as set forth in any one of the foregoing items 1 to 7, wherein the optical transmission factors as determined using light rays having wavelengths of 1300 nm and 1550 nm are not less than 80%.

(9) The optical resin as set forth in any one of the foregoing items 1 to 7, wherein the refractive indexes as determined using light rays having wavelengths of 1300 nm and 1550 nm range from 1.45 to 1.75.

(10) The optical resin as set forth in any one of the foregoing items 1 to 7, wherein the rates of birefringence as determined using light rays having wavelengths of 1300 nm and 1550 nm are not more than 0.008.

(11) An optical waveguide prepared using the optical resin as set forth in any one of the foregoing items 1 to 10.

(12) An optical filter prepared using the optical resin as set forth in any one of the foregoing items 1 to 10.

(13) An optical lens prepared using the optical resin as set forth in any one of the foregoing items 1 to 10.

### BEST MODE FOR CARRYING OUT THE INVENTION

Specific examples of poly(benzoazoles) having repeating units represented by the general formula (1) usable in the present invention are poly(benzoxazoles) and poly(benzothiazoles). These polymers preferably have a number average molecular weight ranging from 10,000 to 200,000. The number of repeating units represented by the general formula (1) included in a poly(benzoazole) molecule ranges preferably from 1 to 500, more preferably from 10 to 400 and particularly preferably from 20 to 300. If the number of repeating units exceeds 500, the polymer is liable to be impaired in the solubility in solvents and the polymer has such a tendency that the viscosity thereof increases and the handling properties thereof are correspondingly impaired.

The poly(benzoxazole) can be prepared by polymerizing a bis(aminophenol) derivative with a dicarboxylic acid derivative to thus form a poly(hydroxyamide) as a precursor for the poly(benzoxazole) and then cyclizing the precursor through dehydration. Alternatively, it is also possible to simultaneously carry out the polymerization of a bis(aminophenol) derivative and a dicarboxylic acid derivative and the cyclization of the resulting product through dehydration to thus directly produce a desired poly(benzoxazole). In this reaction, at least one bis(aminophenol) derivative and at least one dicarboxylic acid derivative are used.

More specifically, the poly(hydroxyamide) as a precursor can be prepared by reacting a bis(aminophenol) derivative and a dicarboxylic acid derivative in a solvent at a temperature of not more than 100° C. In the preparation of the precursor, the polymerizability of the derivatives may be improved by the addition of inorganic salts such as lithium chloride and calcium chloride; and/or bases such as pyridine and triethylamine to the reaction system. Moreover, poly(benzoxazole) in an almost cyclized state can be prepared by a method in which a bis(aminophenol) derivative and a dicarboxylic acid derivative are reacted in their molten state at a temperature of not less than 150° C., without using any solvent or a method in which these starting materials are reacted at a temperature of not less than 150° C. in an organic solvent or polyphosphoric acid.

The poly(benzoxazole) of the present invention preferably comprises fluorine atoms. The fluorine atom content of the poly(benzoxazole) of the present invention preferably ranges from 0 to 50% by mass, more preferably 10 to 45% by mass and most preferably 15 to 40% by mass.

Such a fluorine-containing poly(benzoxazole) is produced using a bis(aminophenol) derivative and a dicarboxylic acid derivative, at least one of which comprises fluorine atoms. Specific examples of such fluorine-containing derivatives are bis(aminophenol) derivatives each having trifluoromethyl group and dicarboxylic acid derivatives each having trifluoromethyl group. The fluorine-containing poly(benzoxazole) of the present invention is one prepared by reacting at least one bis(aminophenol) derivative and at least one dicarboxylic acid derivative, but it is preferred that at least one member selected from the group consisting of the foregoing at least one bis(aminophenol) derivative and the foregoing at least one dicarboxylic acid derivative is a fluorine-containing derivative, while at least one member selected from the foregoing group is a fluorine-free derivative.

Poly(benzothiazole) can be prepared by repeating the same procedures used above in connection with poly(benzoxazole) except for using a bis(aminothiophenol) derivative in place of the foregoing bis(aminophenol) derivative.

Examples of bis(aminophenol) derivatives used in the preparation of poly(benzoxazoles) are 2,4-diamino-1,5-dihydroxybenzene, 3,3′-diamino-4,4′-dihydroxybiphenyl, 4,4′-diamino-3,3′-dihydroxybiphenyl, 2,2′-diamino-3,3′-dihydroxybiphenyl, 3,3′-diamino-2,2′-dihydroxybiphenyl, bis(3-amino-4-hydroxyphenyl)ketone, bis(3-amino-2-hydroxyphenyl)ketone, bis(4-amino-3-hydroxyphenyl)ketone, bis(2-amino-3-hydroxy-phenyl)ketone, bis(3-amino-4-hydroxyphenyl)sulfide, bis(3-amino-2-hydroxyphenyl)sulfide, bis(4-amino-3-hydroxyphenyl)sulfide, bis(2-amino-3-hydroxyphenyl)sulfide, bis(3-amino-4-hydroxyphenyl)sulfone, bis(3-amino-2-hydroxyphenyl)sulfone, bis(4-amino-3-hydroxyphenyl)sulfone, bis(2-amino-3-hydroxyphenyl)sulfone, bis(3-amino-4-hydroxyphenyl)ether, bis(3-amino-2-hydroxyphenyl)ether, bis(4-amino-3-hydroxy-phenyl)ether, bis(2-amino-3-hydroxyphenyl)ether, bis(3-amino-4-hydroxyphenyl)methane, bis(3-amino-2-hydroxyphenyl)methane, bis(4-amino-3-hydroxyphenyl)methane, bis(2-amino-3-hydroxyphenyl)methane, bis(3-amino-4-hydroxyphenyl)difluoromethane, bis(3-amino-2-hydroxyphenyl)difluoromethane, bis(4-amino-3-hydroxyphenyl)difluoromethane, bis(2-amino-3-hydroxyphenyl)difluoromethane, 2,2-bis(3-amino-4-hydroxyphenyl)propane, 2,2-bis(3-amino-2-hydroxyphenyl)propane, 2,2-bis(4-amino-3-hydroxyphenyl)propane, 2,2-bis(2-amino-3-hydroxyphenyl)propane, 2,2-bis(3-amino-4-hydroxyphenyl)hexafluoropropane, 2,2-bis(3-amino-2-hydroxyphenyl)hexafluoropropane, 2,2-bis(4-amino-3-hydroxyphenyl)hexafluoropropane, 2,2-bis(2-amino-3-hydroxyphenyl)hexafluoropropane, and the foregoing compounds in which the hydrogen atoms on the aromatic ring are completely or partially replaced with fluorine, chlorine, bromine and/or trifluoromethyl group.

Examples of bis(aminothiophenol) derivatives used in the preparation of poly-(benzothiazoles) are 2,4-diamino-1,5-dimercaptobenzene, 3,3′-diamino-4,4′-dimercaptobiphenyl, 4,4′-diamino-3,3′-dimercaptobiphenyl, 2,2′-diamino-3,3′-dimercaptobiphenyl, 3,3′-diamino-2,2′-dimercaptobiphenyl, bis(3-amino-4-mercaptophenyl)ketone, bis(3-amino-2-mercaptophenyl)ketone, bis(4-amino-3-mercaptophenyl)ketone, bis(2-amino-3-mercaptophenyl)ketone, bis(3-amino-4-mercaptophenyl)sulfide, bis(3-amino-2-mercaptophenyl)sulfide, bis(4-amino-3-mercaptophenyl)sulfide, bis(2-amino-3-mercaptophenyl)sulfide, bis(3-amino-4-mercaptophenyl)sulfone, bis(3-amino-2-mercaptophenyl)sulfone, bis(4-amino-3-mercaptophenyl)sulfone, bis(2-amino-3-mercaptophenyl)sulfone, bis(3-amino-4-mercaptophenyl)ether, bis(3-amino-2-mercaptophenyl)ether, bis(4-amino-3-mercaptophenyl)ether, bis(2-amino-3-mercaptophenyl)ether, bis(3-amino-4-mercaptophenyl)methane, bis(3-amino-2-mercaptophenyl)methane, bis(4-amino-3-mercaptophenyl)methane, bis(2-amino-3-mercaptophenyl)methane, bis(3-amino-4-mercaptophenyl)difluoromethane, bis(3-amino-2-mercaptophenyl)difluoromethane, bis(4-amino-3-mercaptophenyl)difluoromethane, bis(2-amino-3-mercaptophenyl)difluoromethane, 2,2-bis-(3-amino-4-mercaptophenyl)propane, 2,2-bis(3-amino-2-mercaptophenyl)propane, 2,2-bis(4-amino-3-mercaptophenyl)propane, 2,2-bis(2-amino-3-mercaptophenyl)propane, 2,2-bis(3-amino-4-mercaptophenyl)hexafluoropropane, 2,2-bis(3-amino-2-mercaptophenyl)hexafluoropropane, 2,2-bis(4-amino-3-mercaptophenyl)hexafluoropropane, 2,2-bis(2-amino-3-mercaptophenyl)hexafluoropropane, and the foregoing compounds in which the hydrogen atoms on the aromatic ring are completely or partially replaced with fluorine, chlorine, bromine and/or trifluoromethyl group.

Examples of dicarboxylic acid derivatives usable in the preparation of the poly(benzoazoles) having repeating units represented by the foregoing general formula (1) according to the present invention are aliphatic dicarboxylic acids such as oxalic acid, malonic acid, succinic acid, glutaric acid and adipic acid; and aromatic dicarboxylic acids such as phthalic acid, isophthalic acid, terephthalic acid, 4,4′dicarboxybiphenyl, 2,2′-dicarboxybiphenyl, 2,3′-dicarboxybiphenyl, 3,3′-dicarboxybiphenyl, 3,4′-dicarboxybiphenyl, 4,4′-dicarboxydiphenyl ether, 2,2′-dicarboxydiphenyl ether, 2,3′-dicarboxydiphenyl ether, 3,3′-dicarboxydiphenyl ether, 3,4′-dicarboxydiphenyl ether, 4,4′-dicarboxydiphenyl ketone, 2,2′-dicarboxydiphenyl ketone, 2,3′-dicarboxydiphenyl ketone, 3,3′-dicarboxydiphenyl ketone, 3,4′-dicarboxydiphenyl ketone, 4,4′-dicarboxydiphenyl sulfide, 2,2′-dicarboxydiphenyl sulfide, 2,3′-dicarboxydiphenyl sulfide, 3,3′-dicarboxydiphenyl sulfide, 3,4′-dicarboxydiphenyl sulfide, 4,4′-dicarboxydiphenyl sulfone, 2,2′-dicarboxydiphenyl sulfone, 2,3′-dicarboxydiphenyl sulfone, 3,3′-dicarboxydiphenyl sulfone, 3,4′-dicarboxydiphenyl sulfone, 4,4′-dicarboxydiphenyl methane, 2,2′-dicarboxydiphenyl methane, 2,3′-dicarboxydiphenyl methane, 3,3′-dicarboxydiphenyl methane, 3,4′-dicarboxydiphenyl methane, 4,4′-dicarboxydiphenyl fluoromethane, 2,2′-dicarboxydiphenyl fluoromethane, 2,3′-dicarboxydiphenyl fluoromethane, 3,3′-dicarboxydiphenyl fluoromethane, 3,4′-dicarboxydiphenyl fluoromethane, 4,4′-dicarboxydiphenyl ether, 2,2′-dicarboxydiphenyl ether, 2,3′-dicarboxydiphenyl ether, 3,3′-dicarboxydiphenyl ether and 3,4′-dicarboxydiphenyl ether. Furthermore, examples of dicarboxylic acid derivatives likewise usable in the present invention include halides of dicarboxylic acids such as dichlorides and dibromides of dicarboxylic acids; and dialkyl esters of dicarboxylic acids such as dimethyl esters and diethyl esters thereof.

In the present invention, each of the bis(aminophenol) derivative, the bis(aminothiophenol) derivative and the dicarboxylic acid derivative may be used not only alone, but also in any combination of at least two of them. In this connection, the molar number of the single bis(aminothiophenol) derivative or the total molar number of the combination of at least two bis(aminothiophenol) derivatives is controlled in such a manner that it is identical to or approximately identical to the molar number of the single dicarboxylic acid derivative or the total molar number of the combination of at least two dicarboxylic acid derivatives, in the resulting poly(benzoxazole). On the other hand, the molar number of the single bis(aminothiophenol) derivative or the total molar number of the combination of at least two bis(aminothiophenol) derivatives is controlled in such a manner that it is identical to or approximately identical to the molar number of the single dicarboxylic acid derivative or the total molar number of the combination of at least two dicarboxylic acid derivatives, in the resulting poly(benzothiazole).

The solvent usable in the foregoing polymerization reaction is desirably one capable of dissolving the foregoing derivatives and specific examples thereof include N,N-dimethylacetamide, N,N-dimethylformamide, dimethylsulfoxide, N-methyl-2-pyrrolidone, cyclohexanone, acetone, methyl ethyl ketone, toluene and polyphosphoric acid.

The preparation of a poly(benzoazole) by the dehydration-cyclization of a poly(hydroxyamide) or poly(mercaptoamide) as a precursor is in general conducted by heating. In this connection, the conditions for heating may vary depending on the structures of precursors. In general, the heating temperature herein used ranges from 60 to 400° C. and the heating time ranges from 10 minutes to 5 hours. In this respect, the final heating temperature is desirably increased to a level of not less than the glass transition temperature of the poly(benzoazole).

The optical waveguide loss observed for the resulting poly(benzoazole) is preferably not less than 80%, more preferably not less than 85% and particularly preferably not less than 90% as expressed in terms of the light transmittance as determined using light rays having wavelengths of 1300 nm and 1550 nm. If the light transmittance of the poly(benzoazole) is less than 80%, the optical waveguide loss is very high and such a poly(benzoazole) never shows any satisfactory quality as an optical material.

The refractive index of the poly(benzoazole) preferably falls within the range of from 1.45 to 1.75. If the refractive index thereof is beyond the range specified above, the difference in the refractive index between the poly(benzoazole) and optical fibers or an adhesive for sealing the optical path is considerably increased, this accordingly leads to an increase of, for instance, the reflection loss and such a poly(benzoazole) does not sometimes provide any satisfactory quality required for use as an optical material.

The rate of birefringence of the poly(benzoazole) is preferably not more than 0.008, more preferably not more than 0.007 and particularly preferably 0.006. If the rate of birefringence thereof exceeds 0.008, the anisotropy of the velocity of light waves becomes high and accordingly, such a poly(benzoazole) does not sometimes show any satisfactory quality required for use as an optical material.

The poly(benzoazole) may comprise additives such as a plasticizer, a stabilizer and a refractive index-controlling agent. Moreover, it is also possible to incorporate 0.01 to 50 parts by mass of a filler having an average particle size ranging from 0.005 to 20 μm into the poly(benzoazole) for the improvement of a variety of mechanical and/or optical characteristic properties and to add a UV-absorbing agent thereto.

An example of the method for preparing an optical waveguide is as follows. Poly(hydroxyamide) or poly(mercaptoamide) as a precursor for poly(benzoazole) is coated on the surface of a substrate of, for instance, silicon to a desired thickness (for instance, 2 to 50 μm as determined after drying) using, for instance, a spinner and then the resulting layer is heated at a temperature ranging from 60 to 400° C. for 1 to 6 hours to thus convert the precursor into a poly(benzoazole) film and to form a lower clad layer. Then poly(hydroxyamide) or poly(mercaptoamide) as a precursor for the poly(benzoazole) having a refractive index larger than that of the lower clad layer is coated on the clad layer to a desired thickness (for instance, 2 to 50 μm as determined after drying) and thereafter the resulting layer is heated at a temperature ranging from 60 to 400° C. for 1 to 6 hours to convert the precursor into a poly(benzoazole) film and to thus form a core layer. Subsequently, a metal layer is applied onto the core layer of the resulting assembly by the vapor deposition method, followed by the application of a resist, a pre-baking treatment, exposure to light, development and a post-baking treatment to thus form a patterned resist layer. The metal layer is partially removed through wet etching in such a manner that the shape of the core for an optical waveguide to be formed remains on the assembly and then the poly(benzoazole) is removed by dry etching. Further, the ultimately remaining metal layer serving as the mask for the dry etching is removed through wet etching to thus give a ridge poly(benzoazole) optical waveguide.

In addition, poly(hydroxyamide) or poly(mercaptoamide) as a precursor for the poly(benzoazole) having a refractive index smaller than that of the core layer is coated on the ridge optical waveguide to a desired thickness (for instance, 2 to 50 μm as determined after drying) and thereafter the resulting layer is heated at a temperature ranging from 60 to 400° C. for 1 to 6 hours to thus give an embedded poly(benzoazole) optical waveguide whose upper dad layer is a poly(benzoazole) layer. The upper clad layer is preferably formed from the same resin used for forming the lower clad layer.

An optical filter can, for instance, be prepared as follows: Poly(hydroxyamide) or poly(mercaptoamide) as a precursor for poly(benzoazole) is coated on the surface of a substrate of, for instance, silicon to a desired thickness (for instance, 0.1 to 10 μm as determined after drying) and then the resulting layer is heated at a temperature ranging from 60 to 400° C. for 1 to 6 hours to thus form a thin film of poly(benzoazole). Then a layer of a dielectric material, a semiconductor or a metal serving as a material for an optical thin film is formed on the resulting poly(benzoazole) thin film to thus give an optical filter.

An optical lens can, for instance, be produced as follows: Poly(hydroxyamide) or poly(mercaptoamide) as a precursor for poly(benzoazole) is introduced and sealed in a casting mold having a lens-shaped cavity, the precursor is cyclized by heating at a temperature ranging from 60 to 400° C. for 1 to 6 hours, followed by releasing the product from the casting mold to thus obtain a poly(benzoazole) optical lens.

### EXAMPLES

The present invention will hereunder be described in more specifically with reference to the following Examples, but the present invention is not restricted to these specific Examples at all.

### Example 1

To a 4-necked flask equipped with a stirring machine, there were added 3.66 g (0.01 mole) of 2,2-(3-amino-4-hydroxyphenyl)hexafluoropropane, 0.93 g (0.022 mole) of lithium chloride and 16 g of N-methyl pyrrolidone and the resulting mixture was cooled down to −3° C. with stirring. To the resulting solution, there was added 2.95 g (0.01 mole) of 4,4′-oxybis(benzoyl chloride), followed by stirring the mixture for several minutes, returning the temperature to room temperature (25° C.) and stirring the mixture over additional 24 hours. The reaction solution was dropwise added to excess water to thus precipitate the resulting polymer in the water, followed by filtration and drying of the precipitates thus formed to thus give poly(hydroxyamide). The molecular weight of the resulting polymer was determined by GPC and as a result, it was found to be 43,000 as expressed in terms of the number average molecular weight.

Moreover, the resulting poly(hydroxyamide) was dissolved in N,N-dimethylacetamide to give a solution thereof having a concentration of 30% by mass. The solution was coated on a silicon wafer using a spinner and then the coated layer was treated at 60° C. for 30 minutes, at 100° C. for 30 minutes, at 150° C. for 30 minutes, at 200° C. for 30 minutes, at 250° C. for 30 minutes, at 300 ° C. for 30 minutes and at 350 ° C. for 30 minutes. The resulting film had a thickness of 5 μm and the heat decomposition temperature thereof was found to be not less than 400° C. Moreover, it was found that the resulting film had refractive indexes of 1.5930 (as determined at 1300 nm) and 1.5910 (as determined at 1550 nm) and rates of birefringence of 0.006 (at 1300 nm) and 0.006 (at 1550 nm). The waveguide loss of the resulting film was determined and it was found to be 92% (at 1300 nm) and 91% (at 1550 nm) as expressed in terms of the light transmittance. Furthermore, the fluorine atom content (theoretical value) in the poly(benzoazole) after curing is 21% by mass.

### Example 2

The same procedures used in Example 1 were repeated except that 2.03 g of isophthalic acid anhydride was substituted for the acid chloride used in Example 1 or 4,4′-oxybis(benzoyl chloride) to thus prepare a polymer. The molecular weight of the resulting polymer was found to be 42,000 as expressed in terms of the number average molecular weight. A film having a thickness of 5 μm was formed by the same method used in Example 1, the refractive indexes of the film were determined and they were found to be 1.5662 (at 1300 nm) and 1.5608 (at 1550 nm), the rates of birefringence thereof were found to be 0.007 (at 1300 nm) and 0.007 (at 1550 nm) and the waveguide losses thereof were found to be 91% (at 1300 nm) and 90% (at 1550 nm) as expressed in terms of the light transmittance. The heat decomposition temperature thereof was found to be not less than 400° C. In addition, the fluorine atom content (theoretical value) in the poly(benzoazole) after curing is 25% by mass.

### Comparative Example 1

A film of a polyimide represented by the following structural formula as a high heat-resistant polymer was prepared (a thickness of 5 μm), then the refractive indexes thereof were determined and they were found to be 1.5720 (at 1300 nm) and 1.5665 (at 1550 nm), the rates of birefringence thereof were found to be 0.009 (at 1300 nm) and 0.009 (at 1550 nm) and the waveguide losses thereof were found to be 78% (at 1300 nm) and 75% (at 1550 nm) as expressed in terms of the light transmittance. In addition, the fluorine atom content (theoretical value) in the polyimide after curing is 19% by mass.

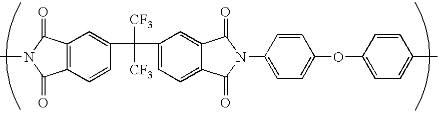

### Comparative Example 2

A film of a poly(quinoline) represented by the following structural formula as a high heat-resistant polymer was prepared (a thickness of 5 μm), then the refractive indexes thereof were determined and they were found to be 1.7711 (at 1300 nm) and 1.7528 (at 1550 nm), the rates of birefringence thereof were found to be 0.085 (at 1300 nm) and 0.071 (at 1550 nm) and the waveguide losses thereof were found to be 65% (at 1300 nm) and 61% (at 1550 nm) as expressed in terms of the light transmittance. In addition, the fluorine atom content (theoretical value) in the poly(quinoline) after curing is 0% by mass.

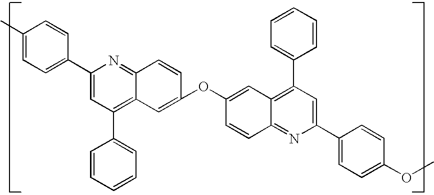

The measured results obtained in the foregoing Examples and Comparative Examples are summarized in the following Table 1.

TABLE 1

| | | | | Comp. | Comp. |
|---|---|---|---|---|---|
| | | | | Ex. 1 | Ex. 2 |
| | | | | (poly- | (poly- |
| Items Determined | | Ex. 1 | Ex. 2 | imide) | quinoline) |
| Refractive Index | 1300 nm | 1.5930 | 1.5662 | 1.5720 | 1.7711 |
| | 1550 nm | 1.5910 | 1.5608 | 1.5665 | 1.7528 |
| Rate of | 1300 nm | 0.006 | 0.007 | 0.009 | 0.085 |
| Birefringence | 1550 nm | 0.006 | 0.007 | 0.009 | 0.071 |
| Light | 1300 nm | 92 | 91 | 78 | 65 |
| Transmittance (%) | 1550 nm | 91 | 90 | 75 | 61 |

The following will be dear from the data listed in Table 1.

The optical resin obtained using poly(benzoazole) according to the present invention shows a change of refractive index as a function of the measuring wavelength falling within the near infrared region substantially smaller than those observed for polyimide and polyquinoline. Moreover, the change in the rate of birefringence observed for the former as a function of the measuring wavelength is superior to that observed for polyquinoline, and is almost identical to that observed for polyimide, and the rate of birefringence thereof is small and accordingly, the optical resin of the present invention is excellent in the optical characteristics. In addition, the transmittance to the light rays falling within the near infrared region is higher than those observed for polyimide and polyquinoline and thus the optical resin of the present invention is excellent in the optical characteristics.

### Example 3

A 20% by mass solution of the polymer prepared in Example 2 in N,N-dimethylacetamide was applied onto the surface of a silicon wafer having a diameter of 5 inches and carrying, on the surface, an SiO₂ film (having a thickness of about 2 μm) according to the spin coating method. The coated layer was stepwise heat-treated under the following conditions: at 60° C. for 30 minutes, at 100° C. for 30 minutes, at 150° C. for 30 minutes, at 200° C. for 30 minutes, at 250° C. for 30 minutes, at 300° C. for 30 minutes and at 350° C. for 30 minutes to thus form a lower clad layer having a thickness of 20 μm. A 20% by mass solution of the polymer prepared in Example 1 in N,N-dimethylacetamide was applied onto the resulting lower clad layer according to the spin coating method and then subjected to heat-treatment under the same conditions used for forming the lower clad layer to form a core layer having a thickness of 6 μm. Then, a resist was coated on the core layer so that the resulting resist layer had a thickness (as determined after drying) of about 1 μm, followed by drying of the layer, irradiation thereof with ultraviolet rays emitted from a super high pressure mercury lamp through a mask for forming a pattern having a line width of 6 μm and the subsequent development using a developer. Thereafter, the polymer was subjected to an RIE (reactive ion etching) processing using a dry etching device. The ultimately remaining resist film was removed to thus give a ridge optical waveguide. Light rays having a wavelength of 1.3 μm were passed through the resulting optical waveguide to determine the light transmission loss according to the cut-back method and as a result, it was found to be 0.3 dB/cm.

### Example 4

The same procedures used in Example 1 were repeated except that 4.29 g of 4,4′-(hexafluoroisopropylidene)-bis(benzoyl chloride) was substituted for the acid chloride used in Example 1 or 4,4′-oxybis(benzoyl chloride) to thus prepare a polymer. The molecular weight of the resulting polymer was found to be 43,000 as expressed in terms of the number average molecular weight. A film was prepared by the same method used in Example 1, the refractive indexes of the film were determined and they were found to be 1.5201 (at 1300 nm) and 1.5180 (at 1550 nm), the rates of birefringence thereof were found to be 0.006 (at 1300 nm) and 0.006 (at 1550 nm) and the waveguide losses thereof were found to be 93% (at 1300 nm) and 93% (at 1550 nm) as expressed in terms of the light transmittance. The heat decomposition temperature thereof was found to be not less than 400° C.

In addition, the fluorine atom content (theoretical value) in the poly(benzoazole) after curing is 33% by mass.

### Example 5

The same procedures used in Example 1 were repeated except that 2.16 g of 3,3′-diamino-4,4′-dihydroxybiphenyl was substituted for the aminophenol used in Example 1 or 2,2-(3-amino-4-hydroxyphenyl)hexafluoropropane and that 4.29 g of 4,4′-(hexafluoroisopropylidene)-bis(benzoyl chloride) was substituted for the acid chloride used in Example 1 or 4,4′-oxybis(benzoyl chloride) to thus prepare a polymer. The molecular weight of the resulting polymer was found to be 56,000 as expressed in terms of the number average molecular weight. A film was prepared by the same method used in Example 1, the refractive indexes of the film were determined and they were found to be 1.6102 (at 1300 nm) and 1.6070 (at 1550 nm), the rates of birefringence thereof were found to be 0.020 (at 1300 nm) and 0.020 (at 1550 nm) and the waveguide losses thereof were found to be 91% (at 1300 nm) and 90% (at 1550 nm) as expressed in terms of the light transmittance. The heat decomposition temperature thereof was found to be not less than 400° C. In addition, the fluorine atom content (theoretical value) in the poly(benzoazole) after curing is 21% by mass.

### Example 6

The same procedures used in Example 1 were repeated except that 2.32 g of oxybis(3-amino-4-hydroxybenzene) was substituted for the aminophenol used in Example 1 or 2,2-(3-amino-4-hydroxyphenyl)hexafluoropropane and that 4.29 g of 4,4′-(hexafluoroisopropylidene)-bis(benzoyl chloride) was substituted for the acid chloride used in Example 1 or 4,4′-oxybis(benzoyl chloride) to thus prepare a polymer. The molecular weight of the resulting polymer was found to be 42,000 as expressed in terms of the number average molecular weight. A film was prepared by the same method used in Example 1, the refractive indexes of the film were determined and they were found to be 1.5932 (at 1300 nm) and 1.5921 (at 1550 nm), the rates of birefringence thereof were found to be 0.006 (at 1300 nm) and 0.006 (at 1550 nm) and the waveguide losses thereof were found to be 93% (at 1300 nm) and 93% (at 1550 nm) as expressed in terms of the light transmittance. The heat decomposition temperature thereof was found to be not less than 400° C. In addition, the fluorine atom content (theoretical value) in the poly(benzoazole) after curing is 21% by mass.

### Example 7

The same procedures used in Example 1 were repeated except that 2.32 g of oxybis(3-amino-4-hydroxybenzene) was substituted for the aminophenol used in Example 1 or 2,2-(3-amino-4-hydroxyphenyl)hexafluoropropane to thus prepare a polymer. The molecular weight of the resulting polymer was found to be 46,000 as expressed in terms of the number average molecular weight. A film was prepared by the same method used in Example 1, the refractive indexes of the film were determined and they were found to be 1.6500 (at 1300 nm) and 1.6476 (at 1550 nm), the rates of birefringence thereof were found to be 0.0015 (at 1300 nm) and 0.0015 (at 1550 nm) and the waveguide losses thereof were found to be 92% (at 1300 nm) and 92% (at 1550 nm) as expressed in terms of the light transmittance. The heat decomposition temperature thereof was found to be not less than 400° C. In addition, the fluorine atom content (theoretical value) in the poly(benzoazole) after curing is 0% by mass.

### Industrial Applicability

The optical resin of the present invention has high transparency to light rays falling within the near infrared region used in the optical communication, shows only small changes in the refractive index and the rate of birefringence as a function of wavelengths of light rays used for the measurement and falling within the near infrared region, has a low rate of birefringence and has high heat-resistance. The optical resin of the present invention can be used not only in the ridge or embedded optical waveguide, but also in the preparation of an optical filter and an optical lens.

What is claimed is:

1. An optical resin comprising a poly(benzoazole) having repeating units represented by the following general formula (1) as a constituent: 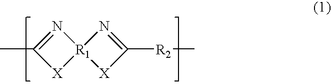
wherein R₁ represents a tetravalent organic group having an aromatic ring, N and X in each of the two sets thereof are linked to two atoms at the ortho-position on the aromatic ring of R₁ to form a 5-membered ring, R₂ represents a divalent organic group and X represents an oxygen atom or a sulfur atom.

2. The optical resin of claim 1, wherein it comprises, as a constituent, a poly(benzoxazole) having repeating units represented by the general formula (1) in which X represents an oxygen atom.

3. The optical resin of claim 2, wherein the poly(benzoxazole) is a fluorine-containing poly(benzoxazole).

4. The optical resin of claim 3, wherein the fluorine-containing poly(benzoxazole) is a product obtained by a reaction of at least one bis(aminophenol) derivative with at least one dicarboxylic acid derivative; at least one member selected from the group consisting of the foregoing at least one bis(aminophenol) derivative and the foregoing at least one dicarboxylic acid derivative is a fluorine-containing derivative and at least one member selected from the foregoing group is a fluorine-free derivative.

5. The optical resin of claim 4, wherein the fluorine-containing bis(aminophenol) derivative is a trifluoromethyl group-containing bis(aminophenol) derivative and the fluorine-containing dicarboxylic acid derivative is a trifluoromethyl group-containing dicarboxylic acid derivative.

6. The optical resin of claim 1, wherein it comprises, as a constituent, a poly(benzothiazole) having repeating units represented by the general formula (1) in which X represents a sulfur atom.

7. The optical resin as set forth in any one of claims 1 to 6, wherein the number of the repeating units represented by the general formula (1) ranges from 1 to 500.

8. The optical resin as set forth in any one of claims 1 to 7, wherein the optical transmission factors as determined using light rays having wavelengths of 1300 nm and 1550 nm are not less than 80%.

9. The optical resin as set forth in any one of claims 1 to 7, wherein the refractive indexes as determined using light rays having wavelengths of 1300 nm and 1550 nm range from 1.45 to 1.75.

10. The optical resin as set forth in any one of claims 1 to 7, wherein the rates of birefringence as determined using light rays having wavelengths of 1300 nm and 1550 nm are not more than 0.008.

11. An optical waveguide prepared using the optical resin as set forth in any one of claims 1 to 10.

12. An optical filter prepared using the optical resin as set forth in any one of claims 1 to 10.

13. An optical lens prepared using the optical resin as set forth in any one of claims 1 to 10.
